(19) United States
(12) Patent Application Publication
(10) Pub. No.: US 2013/0169255 A1
(43) Pub. Date: Jul. 4, 2013

(54) REGULATOR POWER-ON-RESET WITH LATCH

(71) Applicants: Tyler Daigle, Portland, ME (US); Kenneth P. Snowdon, Falmouth, ME (US); Nickole Gagne, Saco, ME (US); Julie Lynn Stultz, Scarborough, ME (US)

(72) Inventors: Tyler Daigle, Portland, ME (US); Kenneth P. Snowdon, Falmouth, ME (US); Nickole Gagne, Saco, ME (US); Julie Lynn Stultz, Scarborough, ME (US)

(21) Appl. No.: 13/341,357

(22) Filed: Dec. 30, 2011

(51) Int. Cl. G05F 1/10

(52) U.S. Cl. 323/284

(57) ABSTRACT

This document discusses, among other things, apparatus and methods for providing a power-on-reset signal. An example apparatus can include a regulator configured to receive a supply voltage and to provide a regulated voltage at an output, and a power-on-reset (POR) circuit including a POR comparator. The POR circuit can be configured to provide an indication that the regulated voltage is below a threshold level using an output of the POR comparator and to disable the POR comparator when the regulated voltage is above the threshold level.

### BACKGROUND

Electronic devices can include circuits, such as power-on-reset (POR) circuits, to ensure that the device powers up in a known state. POR circuits can provide an output having a first state to keep circuitry disabled or reset and a second state to allow circuitry to begin or maintain operation. In certain applications, POR circuits can keep circuitry disabled or reset until a main power supply has ramped up to a minimum voltage level at power-up. However, other power supplies, such as regulated supplies, may not power-up in the same fashion or time interval as the main power supply. In addition, many POR circuits remain powered while the device is powered, accounting for significant power consumption.

### Overview

This document discusses, among other things, apparatus and methods for providing a power-on-reset (POR) signal. An example apparatus can include a regulator configured to receive a supply voltage and to provide a regulated voltage at an output, and a POR circuit including a POR comparator. The POR circuit can be configured to provide an indication that the regulated voltage is below a threshold level using an output of the POR comparator and to disable the POR comparator when the regulated voltage is above the threshold level.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a system including a regulator and an example regulator power-on-reset (POR).

FIG. 2 illustrates generally a regulator and an example regulator POR circuit.

FIG. 3 illustrates generally an example debounce circuit.

FIG. 4 illustrates generally an example regulator POR with a latch.

### DETAILED DESCRIPTION

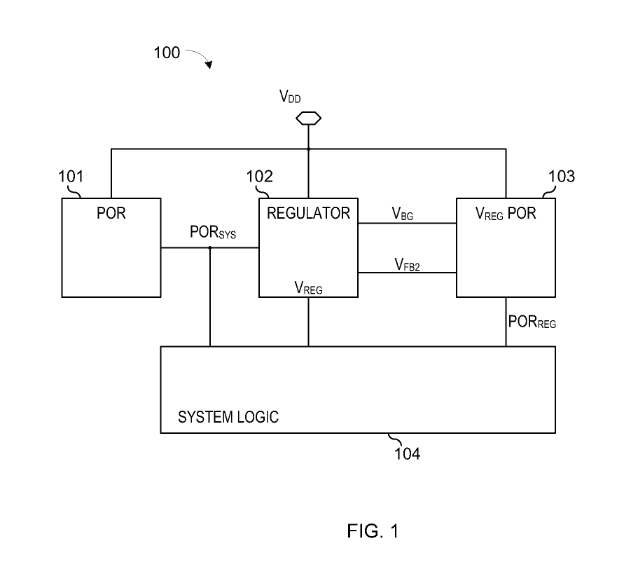

FIG. 1 illustrates generally a system 100 including a system power-on-reset (POR) circuit 101, a regulator 102, a regulator POR circuit 103, and system logic 104. In certain examples, the system POR circuit 101 can provide a POR signal (POR_{SYS}) to put the system logic 104, or portions thereof, in a known state upon start-up, or power-up, of the system 100. In certain examples, the POR signal (POR_{SYS}) can be used to provide a robust system start-up after the supply voltage (V_{DD}) has reached a minimum operating voltage level.

In certain examples, the regulator 102 can use the supply voltage (V_{DD}) to provide a regulated voltage (V_{REG}) to the system logic 104 or a portion thereof. In an example, the regulator 102 can be disabled upon start-up and can be enabled upon receiving the system POR signal (POR_{SYS}). In an example, the regulator 102 can use a bandgap voltage (V_{BG}) to provide the regulated voltage (V_{REG}). In certain examples, the system 100 can include a bandgap voltage source. In an example, the regulator can 102 include an amplifier and a feedback loop to regulate the regulated voltage (V_{REG}).

In certain examples, a regulator POR circuit 103 can provide an indication, such as using a regulator POR signal (POR_{REG}), that a regulated voltage (V_{REG}) is charged up to a desired or threshold voltage level. In certain examples, the regulator POR circuit 103 can receive the bandgap voltage (V_{BG}) and a voltage representative of the regulated voltage (V_{REG}). In an example, the voltage representative of the regulator voltage can include a feedback voltage (V_{FB2}) of the regulator 102. In some examples, the regulator POR circuit 103 can compare the bandgap voltage (V_{BG}) to the regulator feedback voltage (V_{FB2}) to provide the regulator POR signal (POR_{REG}).

In certain examples, an integrated circuit can include the regulator 102 and the regulator POR circuit 103. In an example, the integrated circuit can include a bandgap voltage source. In an example, the integrated circuit can include a system POR circuit 101. In some examples, the integrated circuit can include at least a portion of the system logic 104.

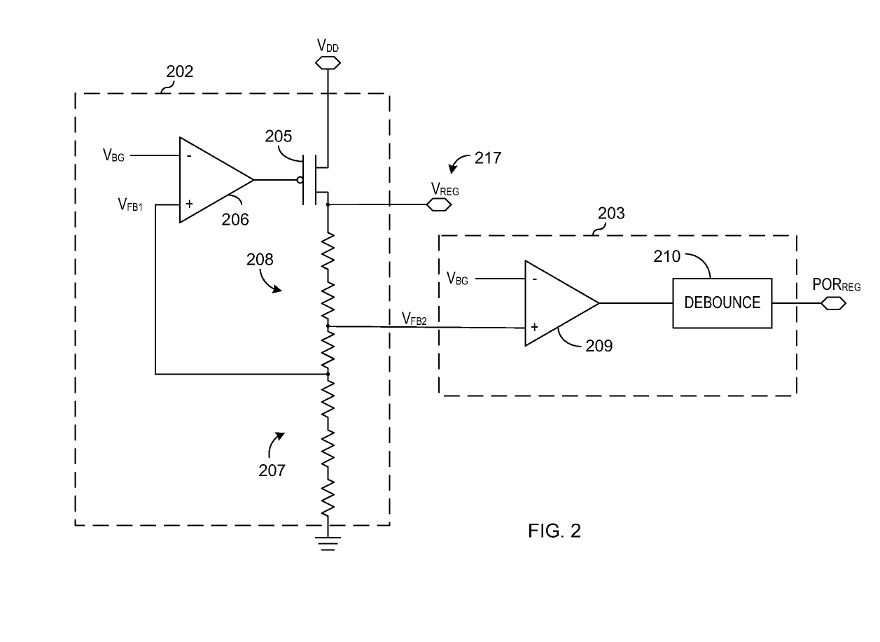

FIG. 2 illustrates generally a regulator 202 and a regulator POR circuit 203. In certain examples, the regulator 202 can receive a supply voltage (V_{DD}) and provide a regulated output voltage (V_{REG}). In certain examples, the regulator 202 can provide the regulated output voltage (V_{REG}) using a transistor circuit controlled by a regulator controller. In some examples, the regulator controller and the transistor circuit can include an error amplifier, such as a power amplifier, where an amplifying stage of the error amplifier can include the transistor circuit. In some examples, the regulator transistor circuit and the regulator controller can include a transistor 205 and an error amplifier 206.

In certain examples, the error amplifier 206 can control the transistor 205 using a comparison of a reference voltage and a first feedback voltage (V_{FB1}) representative of the regulated output voltage (V_{REG}). In an example, the reference voltage can include a bandgap voltage (V_{BG}) configured to allow the regulator 202 to provide a stable regulated voltage (V_{REG}) over a range of temperatures. In some examples, the error amplifier 206 can provide a regulated voltage (V_{REG}) different than the bandgap voltage (V_{BG}), including, in certain examples, a scaled representation of the bandgap voltage (V_{BG}), such as by using a voltage divider 207 in a feedback loop 208.

In an example, a bandgap voltage (V_{BG}) can be coupled to an inverting input of the error amplifier 206 and the feedback loop 208 can be coupled to a non-inverting input of the error amplifier 206. The feedback loop 208 can include a plurality of resistive elements, such as resistors (e.g., semiconductor resistors), coupled between the regulator output 217 and ground. If the regulated voltage (V_{REG}) is low (e.g., comparing the bandgap voltage (V_{BG}) to a first feedback voltage (V_{FB1}), etc.), the output of the error amplifier 206 can be low, allowing more current to pass through the transistor 205 and the feedback loop voltage divider 207, thus raising the regulated voltage (V_{REG}). If the regulated voltage (V_{REG}) is high, the output of the error amplifier 206 can be high, reducing the current through the transistor 205 and the feedback loop voltage divider 207, thus lowering the regulated voltage (V_{REG}).

During start-up, the supply voltage (V_{DD}) can take some time to ramp up to a voltage level capable of robustly operating a device. In certain examples, a regulated voltage (V_{REG}), provided using the supply voltage (V_{DD}), can also take an interval of time to ramp up to a desired voltage level capable of operating electronics configured to receive the regulated voltage (V_{REG}). The regulator POR circuit 203 can provide a regulator POR signal (POR_{REG}) that can be used to disable electronics that rely on the regulated voltage (V_{REG}) until the regulated voltage (V_{REG}) is at least at or above a desired minimum voltage level.

In certain examples, the regulator POR circuit 203 can include a comparator 209. In an example, the comparator 209 can receive a reference voltage indicative of the desired minimum voltage level and a voltage representative of the regulated voltage (V_{REG}). As the signal representative of the regulated voltage (V_{REG}) meets or exceeds the reference voltage, such as a bandgap voltage (V_{BG}), an output of the comparator 209 can switch from a first state to a second state to indicate that the regulated voltage (V_{REG}) is at or above the desired minimum voltage level.

In an example, the signal representative of the regulated voltage can include a second feedback voltage (V_{FB2}) of the regulator 202. In certain examples, the regulator POR circuit 203 can include a debounce circuit 210. As the regulated voltage (V_{REG}), or the voltage representative of the regulated voltage (V_{FB2}), approaches the bandgap voltage (V_{BG}), the output of the comparator 209 can switch between states several times. Such switching can be the result of noise on the supply voltage (V_{DD}), noise of the circuitry of the regulator 202, etc. The debounce circuit 210 can receive the output of the comparator 209 and can delay switching the regulator POR signal (POR_{REG}) from one state to the next until the output of the comparator 209 is stable at the next state for a predetermined interval of time.

In certain examples, the reference voltage for the comparator 209 can include a bandgap voltage (V_{BG}), such as the bandgap voltage (V_{BG}) received by the error amplifier 206 of the regulator 202. In some examples, at least one of the regulator 202 or the regulator POR circuit 203 can include a bandgap voltage source to provide the bandgap voltage (V_{BG}). In certain examples, the voltage representative of the regulated voltage (V_{REG}) can include a feedback voltage of the regulator 202. In an example, the voltage representative of the regulated voltage (V_{REG}) can be a second feedback voltage (V_{FB2}) of the regulator 202. In an example, the second feedback voltage (V_{FB2}) can be selected from a node of the regulator feedback loop 208 that is closer to the regulated voltage (V_{REG}) than the first feedback voltage (V_{FB1}) of the regulator 202.

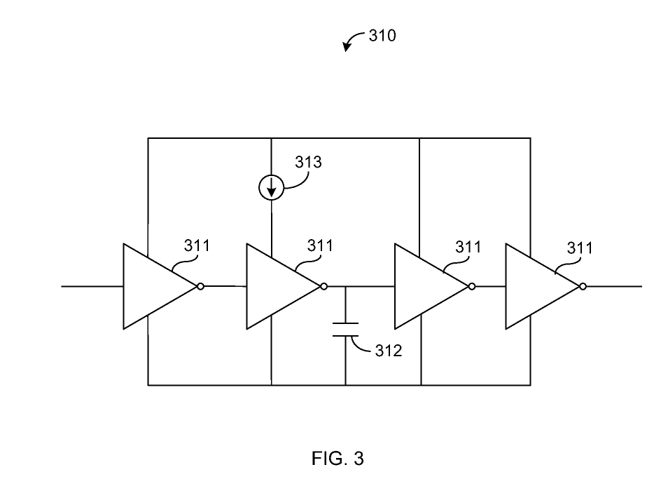

FIG. 3 illustrates generally an example debounce circuit 310. In certain examples, the debounce circuit 310 can include one or more delay elements, such as inverters 311. In some examples, a delay element can include a counter driven by a clock signal such as a clock signal generated from an oscillator. In certain examples, the debounce circuit 310 can include a delay network such as a resistor-capacitor (RC) network. In an example, a delay element can include a capacitor 312 configured to be charged by an inverter 311, which can be powered by a current source 313. In such an example, an even number of inverters 311 can precede the capacitor 312 to ensure that the capacitor 312 is discharged in an off state for a regulator POR signal (POR_{REG}) that is intended to switch from a low state to a high state as the regulated voltage rises to a desired voltage level.

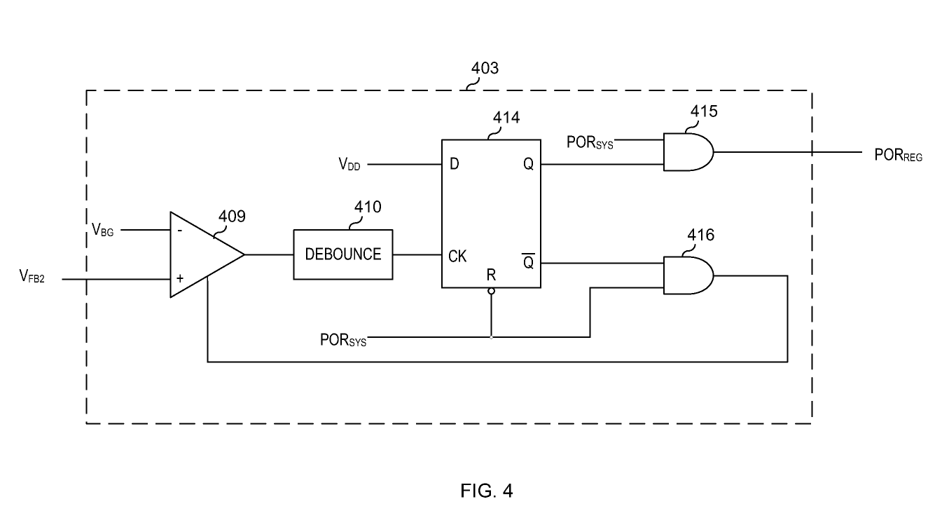

FIG. 4 illustrates a regulator POR circuit 403 that includes a latch and can provide power savings. The regulator POR circuit 403 can include a comparator 409 and a debounce circuit 410, such as described above. In an example, the regulator POR circuit 403 can include a flip-flop 414, such as a D flip-flop, to latch the regulator POR signal (POR_{REG}). In certain examples, the regulator POR circuit 403 can include a first AND gate 415 configured to receive the output of the flip-flop 414 and the system POR signal (POR_{SYS}), such that when both signals are high the regulator POR signal (POR_{REG}) can be asserted.

In certain examples, the system POR signal (POR_{SYS}) can be used to enable the flip-flop 414 and to enable the comparator 409. In such an example, the regulator POR circuit 403 can be disabled until the conditions necessary to set the system POR signal (POR_{SYS}) are satisfied, such as assuring that the system power supply (V_{DD}), received at the flip-flop 414, has ramped to at least a minimum voltage level, for example. In an example, on a rising edge of the system POR signal (POR_{SYS}), the flip-flop 414 can be enabled. In an example, a second AND gate 416 can be used to enable and disable the comparator 409 of the regulator POR circuit 403. For example, the second AND gate 416 can be configured to receive a complement output of the flip-flop 414. In an example, on the rising edge of the system POR signal (POR_{SYS}), the output of the second AND gate 416 can enable the comparator 409 of the regulator POR circuit 403. Upon detection of the regulated voltage (V_{REG}) at or above a minimum voltage level, a rising edge of the signal at the output of the comparator 409 can propagate through the debounce circuit 410 and can trigger a clock input (CK) of the flip-flop 414. In response to a rising clock input, the flip-flop 414 can set a first output (Q) and reset the complement output (Q). In an example, when the regulator POR signal (POR_{REG}) is asserted and latched using the flip-flop 414, the complement output (POR_{SYS}) can go low, disabling the regulator POR comparator 409 via the second AND gate 416. Thus, in certain examples, power can be conserved because the comparator 409 of the regulator POR circuit 403 can be enabled during the time the regulator voltage V_{REG} is evaluated for purposes of asserting the regulator POR signal (POR_{REG}) and can be disabled at most, if not all, other times. In certain examples, once set, the regulator POR signal (POR_{REG}) can be reset when the system POR signal (POR_{SYS}) is reset, such as at power-down.

### Additional Notes and Examples

In Example 1, and apparatus can include a regulator configured to receive a supply voltage and to provide a regulated voltage at an output, and a power-on-reset (POR) circuit including a POR comparator. The POR circuit can be configured to provide an indication of when the regulated voltage is below a threshold level using an output of the POR comparator and to disable the POR comparator when the regulated voltage is above the threshold level.

In Example 2, the regulator of Example 1 optionally includes an error amplifier configured to receive a reference voltage and a first representation of the regulated voltage.

In Example 3, the regulator of any one or more of Examples 1-2 optionally includes a transistor configured to couple the supply voltage to the output using an output of the error amplifier.

In Example 4, the POR circuit of any one or more of Examples 1-3 optionally is configured to receive the reference voltage at a first input of the POR comparator, to receive a second representation of the regulated voltage at a second input of the POR comparator, and to provide an indication that the regulated voltage is below the threshold level using an output of the POR comparator.

In Example 5, a feedback loop of the error amplifier of any one or more of Examples 1-4 optionally is configured to provide the first representation of the regulated voltage at a first node and to provide the second representation of the regulated voltage at a second node, and wherein the first node is different from the second node.

In Example 6, the apparatus of any one or more of claims 1-5 optionally includes a resistor between the first node and the second node.

In Example 7, the reference voltage of any one or more of examples 1-6 optionally includes a bandgap voltage.

In Example 8, the apparatus of any one or more of Examples 1-7 optionally includes a bandgap voltage source configure to provide the bandgap voltage.

In Example 9, an integrated circuit includes the regulator and the POR circuit of any one or more of Examples 1-8.

In Example 10, the integrated circuit of any one or more of Examples 1-9 optionally includes a bandgap voltage source configure to provide the reference voltage.

In Example 11, an apparatus can include a regulator configured to receive a supply voltage at an input and to provide a regulated voltage at an output and a power-on-reset (POR) circuit including a POR comparator. The regulator can includes an error amplifier configured to receive a reference voltage and a first representation of the regulated voltage and a transistor configured to couple the supply voltage to the output using an output of the error amplifier. The POR circuit can be configured to receive the reference voltage at a first input of the POR comparator, to receive a second representation of the regulated voltage at a second input of the POR comparator, and to provide an indication that the regulated voltage is below a threshold level using an output of the POR comparator.

In Example 12, a feedback loop of the error amplifier of any one or more of Examples 1-11 optionally is configured to provide the first representation of the regulated voltage at a first node, to provide the second representation of the regulated voltage at a second node, and wherein the first node is different from the second node.

In Example 13, the apparatus of any one or ore of Examples 1-12 optionally includes a resistor between the first node and the second node.

In Example 14, the POR circuit of any one or more of Examples 1-13 otionally is configured to disable the POR comparator when the regulated voltage is above the threshold level.

In Example 15, the POR circuit of any one or more of Examples 1-14 optionally includes a flip-flop configured to receive the output of the POR comparator, to provide the indication that the regulated voltage is below the threshold level, and to latch a second indication that the regulated voltage is above the threshold level.

In Example 16, the reference voltage of any one or more of Examples 1-15 optionally includes a bandgap voltage.

In Example 17, the apparatus of any one or more of Examples 1-16 optionally includes a bandgap voltage source configure to provide the bandgap voltage.

In Example 18, an integrated circuit optionally includes the regulator and the POR circuit of any one or more of Examples 1-17.

In Example 19, the integrated circuit of any one or more of Examples 1-18 optionally includes a bandgap voltage source configure to provide the reference voltage.

In Example 20, a method can include receiving a supply voltage at a regulator, providing a regulated voltage at an output of the regulator, providing an indication that the regulated voltage is below a threshold level using an output of a POR comparator, and disabling the comparator when the regulated voltage is above the threshold level.

In Example 21, the providing the regulated voltage of any one or more of Examples 1-20 optionally includes receiving, from a first feedback node, a first representation of the regulated voltage at an error amplifier of the regulator, and receiving a reference voltage at a second input of the error amplifier.

In Example 22, the providing the indication of any one or more of Examples 1-21 optionally includes receiving the reference voltage at the POR comparator, receiving, from a second feedback node, a second indication of the regulated voltage at the POR comparator, and comparing the reference voltage and the second indication of the regulated voltage, wherein first feedback node is different than the second feedback node.

In Example 23, the method of any one or more of Examples 1-22 optionally includes latching an indication that the regulated voltage is above the threshold level using a flip-flop.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An apparatus comprising:
a regulator configured to receive a supply voltage and to provide a regulated voltage at an output; and
a power-on-reset (POR) circuit including a POR comparator, the POR circuit configured to provide an indication of when the regulated voltage is below a threshold level using an output of the POR comparator and to disable the POR comparator when the regulated voltage is above the threshold level.

2. The apparatus of claim 1, wherein the regulator includes:
an error amplifier configured to receive a reference voltage and a first representation of the regulated voltage.

3. The apparatus of claim 2, wherein the regulator includes a transistor configured to couple the supply voltage to the output using an output of the error amplifier.

4. The apparatus of claim 2, wherein the POR circuit is configured to receive the reference voltage at a first input of the POR comparator, to receive a second representation of the regulated voltage at a second input of the POR comparator, and to provide an indication that the regulated voltage is below the threshold level using an output of the POR comparator.

5. The apparatus of claim 4, wherein a feedback loop of the error amplifier is configured to provide the first representation of the regulated voltage at a first node and to provide the second representation of the regulated voltage at a second node; and
wherein the first node is different from the second node.

6. The apparatus of claim 5, including a resistor between the first node and the second node.

7. The apparatus of claim 2, wherein the reference voltage includes a bandgap voltage.

8. The apparatus of claim 7, including a bandgap voltage source configure to provide the bandgap voltage.

9. The apparatus of claim 1, wherein an integrated circuit includes the regulator and the POR circuit.

10. The apparatus of claim 9, wherein the integrated circuit includes a bandgap voltage source configure to provide the reference voltage.

11. An apparatus comprising:
a regulator configured to receive a supply voltage at an input and to provide a regulated voltage at an output, the regulator including:
an error amplifier configured to receive a reference voltage and a first representation of the regulated voltage; and
a transistor configured to couple the supply voltage to the output using an output of the error amplifier; and
a power-on-reset (POR) circuit including a POR comparator, the POR circuit configured to receive the reference voltage at a first input of the POR comparator, to receive a second representation of the regulated voltage at a second input of the POR comparator, and to provide an indication that the regulated voltage is below a threshold level using an output of the POR comparator.

12. The apparatus of claim 11, wherein a feedback loop of the error amplifier is configured to provide the first representation of the regulated voltage at a first node;
wherein the feedback loop of the error amplifier is configured to provide the second representation of the regulated voltage at a second node; and
wherein the first node is different from the second node.

13. The apparatus of claim 12, including a resistor between the first node and the second node.

14. The apparatus of claim 11, wherein the POR circuit is configured to disable the POR comparator when the regulated voltage is above the threshold level.

15. The apparatus of claim 11, wherein the POR circuit includes a flip-flop configured to receive the output of the POR comparator, to provide the indication that the regulated voltage is below the threshold level, and to latch a second indication that the regulated voltage is above the threshold level.

16. The apparatus of claim 11, wherein the reference voltage includes a bandgap voltage.

17. The apparatus of claim 16, including a bandgap voltage source configure to provide the bandgap voltage.

18. The apparatus of claim 11, wherein an integrated circuit includes the regulator and the POR circuit.

19. The apparatus of claim 18, wherein the integrated circuit includes a bandgap voltage source configure to provide the reference voltage.

20. A method comprising:
receiving a supply voltage at a regulator;
providing a regulated voltage at an output of the regulator;
providing an indication that the regulated voltage is below a threshold level using an output of a POR comparator; and
disabling the comparator when the regulated voltage is above the threshold level.

21. The method of claim 20, wherein the providing the regulated voltage includes:
receiving, from a first feedback node, a first representation of the regulated voltage at an error amplifier of the regulator; and
receiving a reference voltage at a second input of the error amplifier.

22. The method of claim 21, wherein the providing the indication includes:
receiving the reference voltage at the POR comparator;
receiving, from a second feedback node, a second indication of the regulated voltage at the POR comparator; and
comparing the reference voltage and the second indication of the regulated voltage, wherein first feedback node is different than the second feedback node.

23. The method of claim 20, including latching an indication that the regulated voltage is above the threshold level using a flip-flop.
